(19) United States
(12) Patent Application Publication
(10) Pub. No.: US 2025/0311071 A1
(43) Pub. Date: Oct. 2, 2025

(54) METHOD AND APPARATUS FOR DIGITAL DISPLAY UPDATE

(71) Applicant: TEXAS INSTRUMENTS INCORPORATED, Dallas, TX (US)

(72) Inventors: Chih Pu Yeh, Shanghai (CN); Yanqin Cao, Shanghai (CN)

(21) Appl. No.: 18/621,277

(22) Filed: Mar. 29, 2024

(51) Int. Cl. H05B 45/14; H05B 45/325; H05B 47/11; H05B 47/16

(52) U.S. Cl. CPC H05B 45/14; H05B 45/325; H05B 47/11; H05B 47/16

(57) ABSTRACT

A circuit comprises a clock, a counter, and a controller. The counter is connected to the clock. The controller is connected to the counter. The controller is configured to control a display brightness according to a brightness value and a count of the counter. The controller is further configured to perform, upon receiving the brightness value at an input, a digital display brightness update at a temporally proximate PWM segment in a clock frame. A positive integer number of PWM segments occur within the clock frame. The clock frame corresponds to a counted duration corresponding to a counting range of the counter. Contiguous counting is performed over an entirety of the clock frame. The controller causes uninterrupted illumination to be maintained from a first display frame to a second display frame, the second display frame being immediately subsequent to the first display frame.

### BACKGROUND

An electronic display can be used to display information on or from an electronic device, for example, a telephone, tablet, laptop computer, desktop computer, television, vehicle subsystem, or other electronic instrument. An illumination feature can be provided in an electronic display. For example, an array of light-emitting diodes (LEDs) can be used to provide a lighted display. The LEDs can serve to form the image to be displayed, or that image can be formed by the use of the LEDs for backlighting another display panel layer, such as a liquid-crystal-display (LCD) layer, where the LCD layer may be used to form the image to be displayed. A method and apparatus is provided to adjust the brightness of the illumination feature of the electronic display.

### SUMMARY

A circuit comprises a clock, a counter, and a controller. The counter is connected to the clock. The controller is connected to the counter. The controller is configured to control a display brightness according to a brightness value and a count of the counter. The controller is further configured to perform, upon receiving the brightness value at an input, a digital display brightness update at a temporally proximate PWM segment in a clock frame. A positive integer number of PWM segments occur within the clock frame. The clock frame corresponds to a counted duration corresponding to a counting range of the counter. Contiguous counting is performed over an entirety of the clock frame. The controller causes uninterrupted illumination to be maintained from a first display frame to a second display frame, the second display frame being immediately subsequent to the first display frame.

### BRIEF DESCRIPTION OF THE DRAWINGS

FIG. 1 is a block diagram illustrating an apparatus in accordance with some aspects of the present disclosure.

FIG. 2 is a block diagram illustrating a circuit in accordance with some aspects of the present disclosure.

FIG. 3 is a timing diagram illustrating temporal operational elements in accordance with some aspects of the present disclosure.

FIG. 4 is a timing diagram illustrating temporal operational elements in accordance with some aspects of the present disclosure.

FIG. 5 is a schematic diagram illustrating a circuit in accordance with some aspects of the present disclosure.

FIG. 6 is a timing diagram illustrating temporal operational elements in accordance with some aspects of the present disclosure.

FIG. 7 is a flow diagram illustrating a method in accordance with some aspects of the present disclosure.

FIG. 8 is a flow diagram illustrating a method in accordance with some aspects of the present disclosure.

### DETAILED DESCRIPTION

The drawings are not drawn to scale.

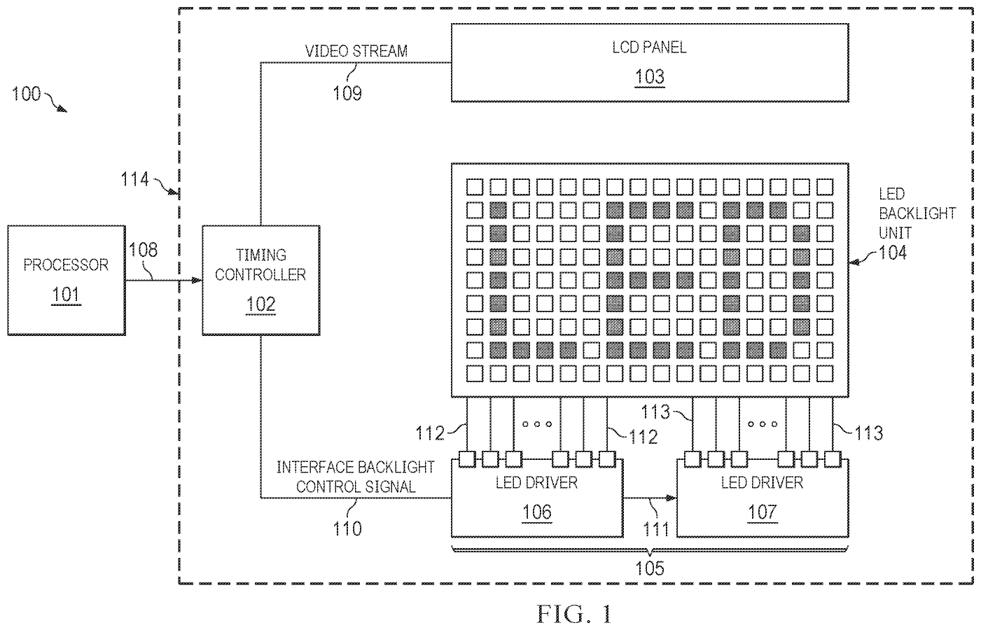

FIG. 1 is a block diagram illustrating an apparatus in accordance with some aspects of the present disclosure. Apparatus 100 comprises processor 101 and display subsystem 114. Display subsystem 114 comprises timing controller 102, liquid-crystal-display (LCD) panel 103, light-emitting-diode (LED) backlight unit 104, and LED driver circuit 105. As an example, LED driver circuit 105 can comprise a plurality of LED driver circuits, such as LED driver circuit 106 and LED driver circuit 107. Processor 101 is connected to timing controller 102 via interconnect 108. Timing controller 102 is connected to LCD panel 103 via interconnect 109. Timing controller 102 is connected to LED driver circuit 105 (e.g., LED driver circuit 106) via interconnect 110. LED driver circuit 106 is connected to LED driver circuit 107 via interconnect 111. LED driver circuit 106 is connected to LED backlight unit 104 via interconnect 112. LED driver circuit 107 is connected to LED backlight unit 104 via interconnect 113.

Processor 101 provides, for example, information to be displayed to display subsystem 114 via interconnect 108. Processor 101 can also provide information such as display control parameter values to display subsystem 114 via interconnect 108. The display control parameter values can include a brightness value or other indicia of desired display brightness. Timing controller 102 receives the information from processor 101. In an implementation using a display panel layer (e.g., LCD panel 103) for image formation of a displayed image, timing controller 102 provides image content (e.g., a video stream) to the image formation layer (e.g., LCD panel 103). Timing controller 102 provides information to drive an illumination layer (e.g., LED backlight unit 104). As an example, timing controller 102 provides an illumination control signal (e.g., a backlight control signal) to LED driver circuits 105. As an example, timing controller 102 can provide an illumination control signal to a first LED driver circuit 106, and the first LED driver circuit 106 can relay a portion of the illumination control signal applicable to a second LED driver circuit 107 to that second LED driver circuit 107 (e.g., via interconnect 111). Based on the illumination control signal, LED driver circuits 105 can drive an array (e.g., a rectilinear array) of LEDs in LED backlight unit 104 via interconnects 112 and 113.

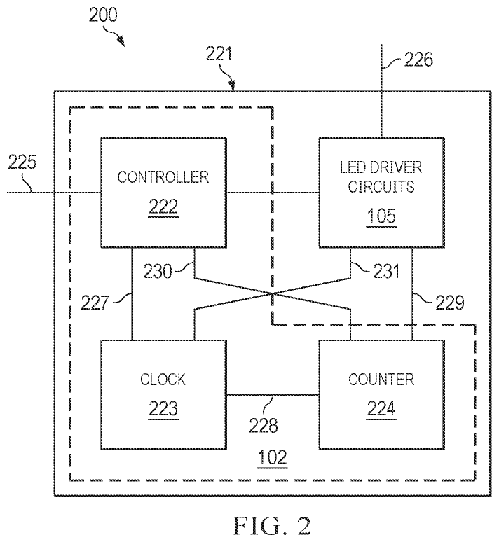

FIG. 2 is a block diagram illustrating a circuit in accordance with some aspects of the present disclosure. Circuit 200 comprises timing controller 102 and LED driver circuits 105. Timing controller 102 comprises controller 222, clock 223, and counter 224. Input 225 is connected to controller 222. Controller 222 is connected to clock 223 via interconnect 227. Clock 223 is connected to counter 224 via interconnect 228. Counter 224 is connected to LED driver circuits 105 via interconnect 229. Controller 222 is connected to counter 224 via interconnect 230. Clock 223 is connected to LED driver circuits 105 via interconnect 231. LED driver circuit 105 are connected to output 226. As an example, controller 222 can comprise a processor. Controller 222 can comprise a memory. Instructions may be stored in the memory. The processor can retrieve the instructions from the memory and execute the instructions to control operation of the circuit.

Controller 222 can receive information (e.g., display control parameter values) via input 225. As an example, information at input 225 can be provided by a processor, such a processor 101 of FIG. 1. Clock 223 provides a clock signal at a clock rate. The clock signal comprises clock pulses at clock pulse intervals having a duration of a clock period. Counter 224 counts clock pulses of the clock signal. Counter 224 can count a duration of a clock frame. Counter 224 begins its count at an initial count value at the beginning of a clock frame and counts to a final count value at the end of a clock frame. After the end of a clock frame is reached, the count of counter 224 is reset to its initial count value, from which it begins its count of the next clock frame.

Counter 224 can count temporal subdivisions of a clock frame. The temporal subdivisions make be used to implement a time-domain brightness control technique, such as pulse-width modulation (PWM). With PWM, an illumination source, such as a LED, can be turned on and off rapidly to produce an impression of brightness that can have an intermediate brightness value between an always-on full brightness and an always-off darkness. The switching rate of an illumination source in PWM can be fast enough that persistence of vision gives the appearance of constant brightness rather than flickering between on and off states. By varying the amount of time an illumination source is on (on-time) compared to the amount of time an illumination source is off (off-time), varying levels of perceived brightness can be provided.

The temporal subdivisions of a clock frame can be referred to as PWM segments. PWM segments can be used to implement PWM, for example by turning on an illumination source for one or more PWM segments within a clock frame and turning off the illumination source for one or more PWM segments within a clock frame. As a PWM segment can span a plurality of clock periods of the clock, finer resolution PWM, which can be referred to as enhanced-spectrum PWM (ES-PWM), can be implemented by dividing the on and off times into periods (e.g., one or more clock periods) shorter than a PWM segment. Shorter illumination periods can be distributed among a plurality of PWM segments within a clock frame.

According to a brightness value, controller 222 can control LED driver circuit 105 to provide a desired brightness level based on a PWM pattern (e.g., an ES-PWM pattern) corresponding to the brightness value according to PWM segments established by the counting of counter 224 of the clock signal of clock 223. Controller 222 can perform a display brightness update in response to receiving a brightness value. Controller 222 can perform the display brightness update promptly (e.g., as soon as the next PWM segment following receipt of the brightness value, within a few PWM segments following receipt of the brightness value, before the end of the same clock frame in which the brightness value was received, or the like). Operation of counter 224 can continue uninterrupted regardless of receipt of a brightness value and regardless of performance of display brightness update within a clock frame.

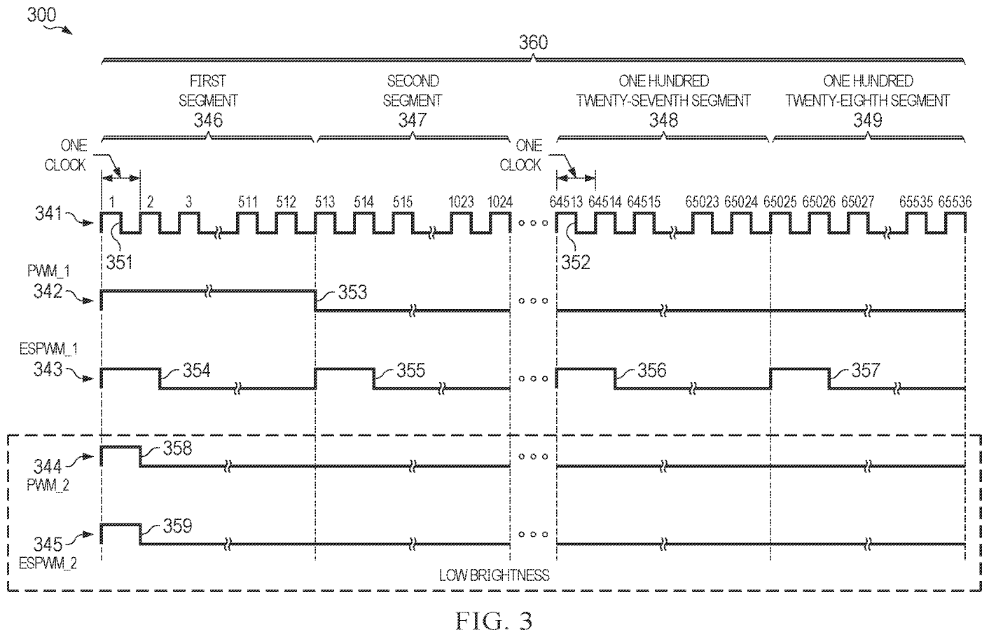

FIG. 3 is a timing diagram illustrating temporal operational elements in accordance with some aspects of the present disclosure. An apparatus (e.g., a circuit) operates with respect to a plurality of clock signals 300. As an example, the apparatus can generate some or all of such clock signals. A clock (e.g., clock 223) provides a clock signal 341 with clock pulses (e.g., clock pulses 351, 352) during a plurality of PWM segments (e.g., PWM segments 346, 347, 348, and 349) within a clock frame 360. A positive integer number (e.g., 128) of PWM segments occur within clock frame 360. In accordance with at least one embodiment, the positive integer number of PWM segments is invariant across clock frames, regardless of whether or not a display brightness update occurs within a particular clock frame or not.

In a first example for a PWM implementation, as shown by PWM signal 342, illumination occurs during a portion 353 of the clock frame. In accordance with at least one embodiment, the remainder of the clock frame remains unilluminated. In a second example for a PWM implementation, at low brightness levels, as shown by PWM signal 344, illumination occurs during a portion 358, which may be of a number of clock cycles of clock pulses 351 shorter than a PWM segment (e.g., PWM segment 346) within clock frame 360.

In a first example of an enhanced-spectrum-PWM (ES-PWM) implementation, as shown by ESPWM signal 343, periods of illumination are distributed among the PWM segments within a clock frame. As shown, periods of illumination occur during portions 354, 355, 356, and 357 within PWM segments 346, 347, 348, and 349, respectively. Accordingly, the temporal granularity of switching of illumination according to a PWM value can be increased. Higher temporal granularity can avoid flickering, whether viewed by a biological viewer (e.g., a human) with persistence of vision or by an electronic viewer (e.g., a camera) with an exposure time over which light is received to form an image.

In a second example of an ES-PWM implementation, brightness levels lower than or equal to the number of segments in one clock frame would be provided by one clock cycle of illumination per PWM segment and can be obtained by causing illumination during one or more PWM segments and leaving the display unilluminated during other PWM segments. As shown by ES-PWM signal 345, a period of illumination occurs (e.g., for one clock cycle) during portion 359 in PWM segment 346, but the display is unilluminated during PWM segments 347, 348, and 349. In other examples, periods of illumination could be distributed among some but not all of the PWM segments. As an example, a period of illumination could occur during the first, 33^{rd}, 65^{th}, and 97^{th} PWM segments of a 128-PWM-segment clock frame.

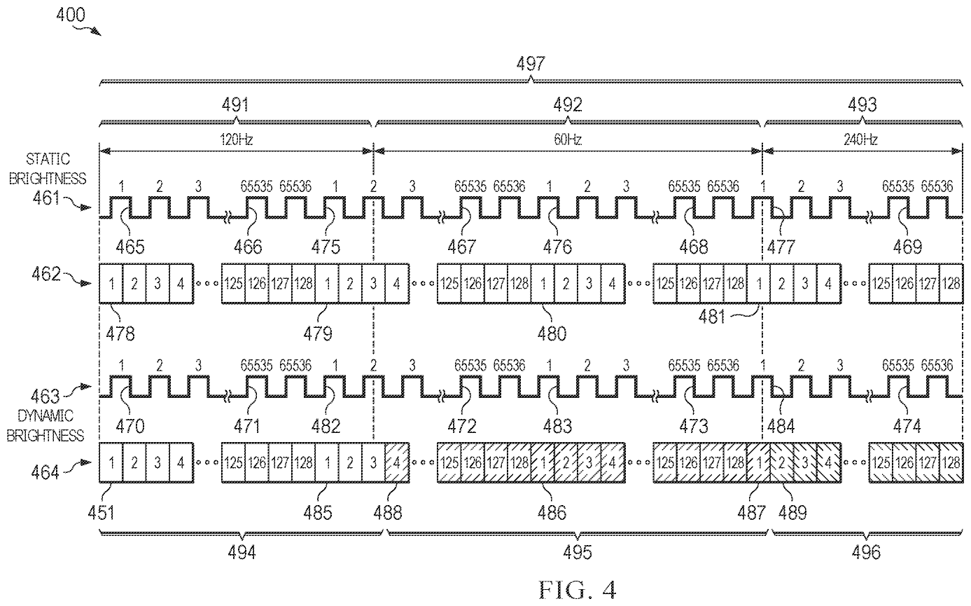

FIG. 4 is a timing diagram illustrating temporal operational elements in accordance with some aspects of the present disclosure. An apparatus (e.g., a circuit) operates with respect to a plurality of clock signals 400. As an example, the apparatus can generate some or all of such clock signals. A clock (e.g., clock 223) provides a clock signal 461 with clock pulses (e.g., clock pulses 466, 467, 468, and 469) during a plurality of PWM segments within a clock frame 497. A positive integer number (e.g., 128) of PWM segments occur within clock frame 497. In accordance with at least one embodiment, the positive integer number of PWM segments is invariant across clock frames, regardless of whether or not a display brightness update occurs within a particular clock frame or not.

In accordance with at least one embodiment, the apparatus can support displays with changing display refresh rates, such as variable-refresh-rate displays. As an example, a first refresh rate (e.g., 120 Hz) may be used during a first refresh-rate period 491, a second refresh rate (e.g., 60 Hz) may be used during a second refresh-rate period 492, and a third refresh rate (e.g., 240 Hz) may be used during a third refresh-rate period 493. While the examples of refresh rates of 120 Hz, 60 Hz, and 240 Hz are stated, other refresh rates, higher or lower, may be used. As another example, refresh rates of 120 Hz, 60 Hz, 119 Hz, or other frequencies may be used. The changes in refresh rate need not be in temporal alignment with PWM segment boundaries. For example, PWM segments 462 extend from a first PWM segment to a 128th PWM segment of each of a plurality of clock frames, with first PWM segments 478, 479, 480, and 481 at the beginnings of different clock frames, corresponding to first clock pulses 465, 475, 476, and 477 of clock signal 461. As shown, a refresh-rate change can occur in any PWM segment of a clock frame, such as in a first PWM segment of a clock frame, for example first PWM segment 481 for the change from the 60-Hz refresh rate to the 240-Hz refresh rate, or in a later PWM segment, such as in the case of the change from the 120-Hz refresh rate to the 60-Hz refresh rate.

In accordance with at least one embodiment, a display brightness update can be performed at any PWM segment within a clock frame. A clock (e.g., clock 223) provides a clock signal 463 with clock pulses (e.g., clock pulses 471, 472, 473, and 474) during a plurality of pulse-width-modulation (PWM) segments within a clock frame 497. A first period 494 during which the display is illuminated at a first brightness level begins at PWM segment 451. A second period 495 during which the display is illuminated at a second brightness level begins at PWM segment 488. A third period 496 during which the display is illuminated at a third brightness level begins at PWM segment 489. As shown, PWM segment 451 is the first PWM segment of a clock frame, whereas PWM segment 488 comes after first PWM segment 485 of its clock frame and before first PWM segment 486 of the next clock frame, and PWM segment 489 comes after first PWM segment 487 of its clock frame. In the illustrated example, the display brightness updates correspond to the changes in display refresh rates, but display brightness updates may occur at other times. Such times need not be temporally aligned with clock frame boundaries or display refresh rate boundaries.

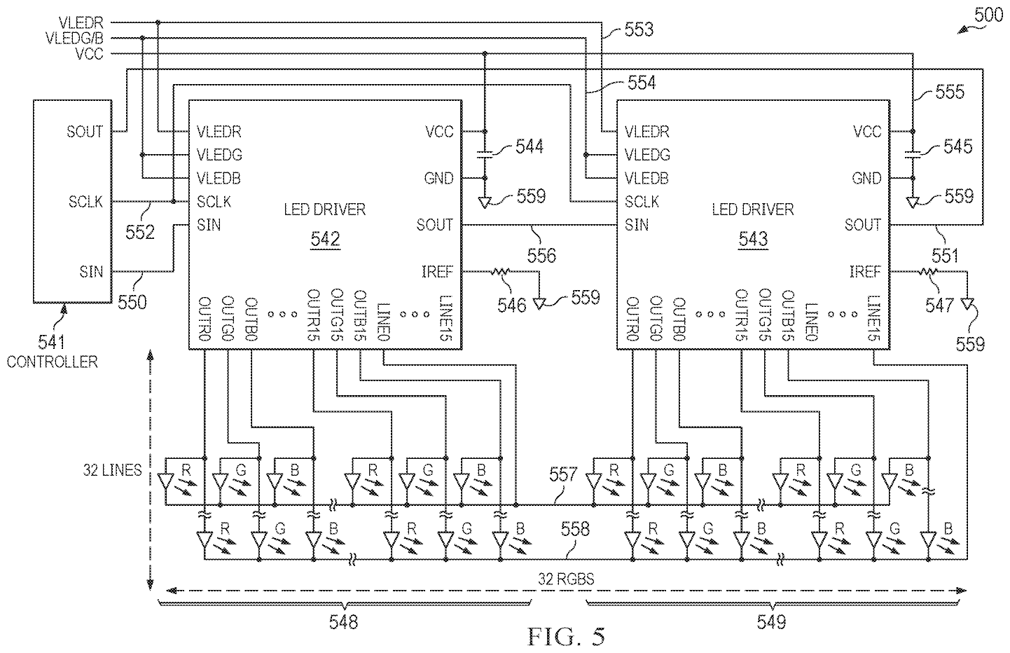

FIG. 5 is a schematic diagram illustrating a circuit in accordance with some aspects of the present disclosure. Circuit 500 comprises controller 541 and at least one LED driver circuit, such as LED driver circuit 542 and LED driver circuit 543. A plurality of voltages are provided to the circuit. As examples, a red LED voltage (VLEDR) is supplied at red LED voltage input 553, a green and blue LED voltage (VLEDG/B) is supplied at green and blue LED voltage input 554, and a supply voltage (VCC) is supplied at supply voltage input 555. Controller 541 is connected to LED driver circuit 542 and to LED driver circuit 543 via an interface. As an example, the interface is implemented using serial input (SIN) line 550, serial output (SOUT) line 551, and serial clock (SCLK) line 552. As an example, LED driver circuit 542 and LED driver circuit 543 may be daisy-chained, with SIN line 550 connected to a SIN input of LED driver circuit 542, a SOUT output of LED driver circuit 542 connected to a SIN input of LED driver circuit 543 via line 556, and a SOUT output of LED driver circuit 543 connected to SOUT line 551. A capacitor, such as capacitor 544 and capacitor 545, may be connected between supply voltage input 555 and ground 559. A resistor, such as resistor 546 and resistor 547, may be connected between a current reference (IREF) terminal of a LED driver circuit, such as LED driver circuit 542 or LED driver circuit 543, and ground 559. LED outputs of LED driver circuit 542 may be connected to a LED array 548. LED outputs of LED driver circuit 543 may be connected to a LED array 548. Each LED array may comprise LEDs of a plurality of colors, such as red, green, and blue (RGB), to provide a multichromatic display. Rows of LEDs may be connected to respective line terminals (e.g., line terminal 557 and line terminal 558) of at least one LED driver circuit to allow multiplexing of the LED arrays according to rows and columns. As an example, one terminal (e.g., an anode) of a LED may be connected to a LED output corresponding to its column, and another terminal (e.g., a cathode) of a LED may be connected to a line terminal corresponding to its row. Accordingly, a two-dimensional array of LEDs may be efficiently selectively illuminated by multiplexing row and column drive signals over time.

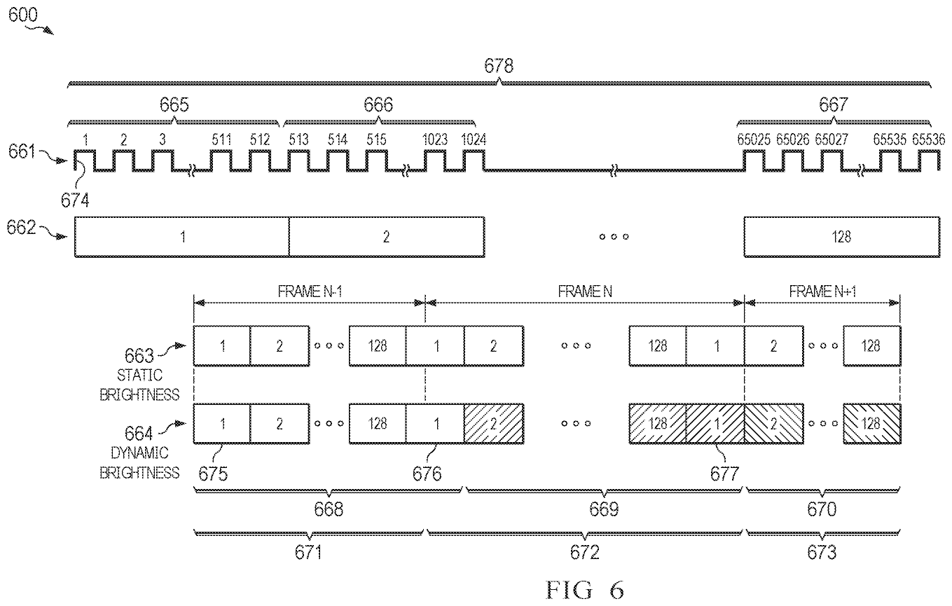

FIG. 6 is a timing diagram illustrating temporal operational elements in accordance with some aspects of the present disclosure. An apparatus (e.g., a circuit) operates with respect to a plurality of clock signals 600. As an example, the apparatus can generate some or all of such clock signals. A clock (e.g., clock 223) provides a clock signal 661 with clock pulses 674 during a plurality of pulse-width-modulation (PWM) segments 662 (e.g., PWM segments 665, 666, and 667) within a clock frame 678. A positive integer number (e.g., 128) of PWM segments occur within clock frame 678. In accordance with at least one embodiment, the positive integer number of PWM segments is invariant across clock frames, regardless of whether or not a display brightness update occurs within a particular clock frame or not.

The lower portion of FIG. 6, drawn at a different scale than upper portion of FIG. 6, shows a relationship of display brightness updates to display frames and to clock frames in accordance with at least one embodiment. For an example of static display brightness, a series of PWM segments 663 are shown. For an example of dynamic display brightness, a series of PWM segments 664 are shown. A first clock frame begins at PWM segment 675. A second clock frame begins at PWM segment 676. A third clock frame begins at PWM segment 677.

The series of PWM segments 663 and 664 span a sequence of three display frames comprising a previous (N−1^{st}) display frame 671, a current (N^{th}) display frame 672, and a next (N+1^{st}) display frame 673. With the series of PWM segments 664, two display brightness updates occur. A first display brightness is in effect over a period 668. A second display brightness is in effect over a period 669. A third display brightness is in effect over a period 670.

A display brightness update may be initiated when a new display frame is displayed or at a different time. As shown, the current display frame 672 begins during the first PWM segment 676 of the second clock frame. If the current display frame 672 initiates the display brightness update for period 669, its arrival time is shown as slightly after the beginning of the second clock frame. If display brightness updates were able to be performed only at the beginning of a clock frame, the display brightness update for period 669 would be delayed until PWM segment 677 at the beginning of the third clock frame. However, by providing an ability to perform a display brightness update at any PWM segment, a display brightness update initiated at the beginning of current display frame 672 can be made effective at the PWM segment immediately following first PWM segment 676, during which the display brightness update was initiated.

Similarly, the next display frame 673 begins during the first PWM segment 677 of the third clock frame. If the next display frame 673 initiates the display brightness update for period 670, its arrival time is shown as slightly after the beginning of the third clock frame. If display brightness updates were able to be performed only at the beginning of a clock frame, the display brightness update for period 670 would be delayed until after period 670. However, a display brightness update initiated at the beginning of the next display frame 673 can be made effective at the PWM segment immediately following the first PWM segment 677, during which the display brightness update was initiated.

Even if a display brightness update is initiated at a time other than the beginning of a display frame, the ability to perform a display brightness update at any PWM segment allows a display brightness update to be performed shortly after it is initiated, for example, at the PWM segment immediately following the PWM segment in which the display brightness update was initiated, regardless of how far from a clock frame boundary those PWM segments may be. Accordingly, long delays of display brightness updates and display flickering may be avoided.

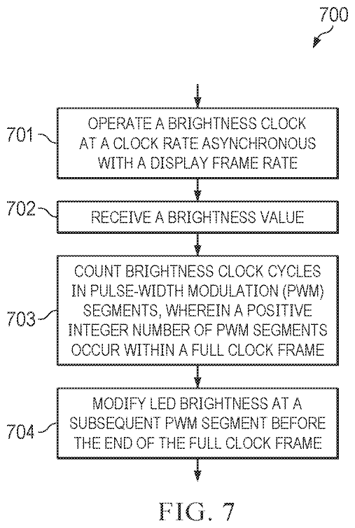

FIG. 7 is a flow diagram illustrating a method in accordance with some aspects of the present disclosure. Method 700 comprises blocks 701, 702, 703, and 704. At block 701, where a clock, which may be referred to as a brightness clock, is operated at a clock rate, which may be asynchronous with a display frame rate. As an example, a clock may operate at a fixed clock rate different from a display frame rate. At block 702, a brightness value is received. The brightness value may be received at a time not aligned with a temporal boundary of a clock frame based on the clock. As an example, the brightness value may be received at any time within a clock frame. At block 703, brightness clock cycles are counted in PWM segments. A positive integer number of PWM segments occur within a clock frame. While counting is shown to occur at block 703, counting can begin prior to receipt of a brightness value at block 702 and can continue after receipt of the brightness value at block 702. At block 704, LED brightness is modified at a subsequent PWM segment before the end of the clock frame in which the brightness value was received. As an example, the LED brightness may be modified at the start of a subsequent PWM segment before the end of the clock frame. The clock frame can continue to its full extent (e.g., to the counting limit of the counter). Premature truncation of the count can be avoided. By modifying the LED brightness at the start of a subsequent PWM segment, a PWM or ES-PWM pattern for that PWM segment corresponding to the new LED brightness level can implemented across that entire PWM segment. The counts of the counter at which the brightness value is received and at the subsequent PWM segment at which the LED brightness is modified can be arbitrary values within the counting range of the counter (e.g., those counts need not be at the end or beginning of a counting sequence of the counter).

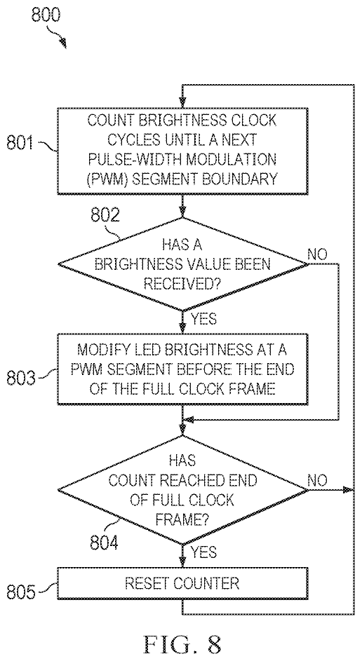

FIG. 8 is a flow diagram illustrating a method in accordance with some aspects of the present disclosure. Method 800 comprises block 801, decision block 802, block 803, decision block 804, and block 805. At block 801, clock cycles, which may be referred to as brightness clock cycles, are counted until a next PWM segment boundary. At decision block 802, a decision is made whether or not a brightness value has been received. If not, method 800 continues to decision block 804. If so, method 800 continues to block 803. At block 803, LED brightness is modified at a PWM segment before the end of the clock frame in which the brightness value was received. At decision block 804, a decision is made as to whether or not the count has reached the end of the clock frame. If so, method continues to block 805, where the counter is reset, then method 800 returns to block 801. If not, method 800 returns to block 801 without resetting the counter.

In accordance with at least one embodiment, a circuit performs an uninterrupted brightness update. The uninterrupted brightness update provides continuous illumination of a display, which can avoid flickering of the display.

In display technology, a display frame rate, also known as a display refresh rate, refers to a frequency at which a display updates the on-screen image. Along with updating the on-screen image, the brightness data may be updated at the same intervals.

In many applications, the display refresh rate is fixed value such as 60 Hz, 120 Hz, 240 Hz, etc. In some scenarios (e.g., gaming), a variable refresh rate (VRR) can be used for smoother image processing and to avoid image stuttering. In VRR, the brightness data update frequency can be unexpected and can occur in the context of a wide range of refresh rates (e.g., 60 to 240 Hz). At least one embodiment as disclosed herein can implement prompt display brightness updates over large operational ranges (e.g., over a large range of refresh rates, including refresh rates implemented using VRR). At least one embodiment as disclosed herein can avoid flickering from long display brightness update latencies and timing irregularities that might otherwise affect a display brightness update and its resulting display image quality.

In accordance with at least one embodiment, PWM dimming can be used for high resolution (e.g., 16-bit resolution). Techniques as disclosed herein can be used to promptly perform a display brightness update at a temporally proximate arbitrary PWM segment rather than having to wait until all PWM segments of a clock frame have occurred. Accordingly, such a display brightness update can be referred to as an uninterrupted brightness update (UBU), as the display brightness update can be performed immediately rather than interrupting it until the beginning of the next clock frame.

In accordance with at least one embodiment, a display brightness update can be promptly performed even if a clock asynchronous with a display refresh rate is used to provide the PWM segments of a PWM or ES-PWM brightness control technique. As an example, a fixed-rate clock can be used even if the display refresh rate varies (e.g., with VRR). A fixed-rate clock can avoid the complexity of implementing an adaptive-rate clock (e.g., a PLL).

In accordance with at least one embodiment, a fixed-frequency clock and counter can be used to implement PWM illumination durations. The PWM frequency can be boosted using ES-PWM. ES-PWM can distribute the illuminated duration for a particular PWM brightness level across multiple PWM segments. The display brightness (output brightness) can be maintained continuously before a next brightness update occurs. A display brightness update can be performed without resetting the counter. Avoiding resetting the counter can maintain invariant clock frame durations regardless of the occurrence or non-occurrence of display brightness updates during a clock frame.

In accordance with at least one embodiment, the techniques disclosed herein can be implemented using ES-PWM. PWM durations of illumination can be rendered equally (or approximately equally) into segments (e.g., into 128 segments of 512 clock cycles for a 65,536-cycle clock frame of a 16-bit counter). With ES-PWM, a display brightness level may be implemented with a higher PWM frequency. Raising the PWM frequency using ES-PWM can avoid audible display noise (e.g., by implementing a PWM frequency above a highest audible frequency, such as 20 KHz. A high PWM frequency can also avoid human eye fatigue.

In accordance with at least one embodiment, for low display brightness levels, not all PWM segments need to include an illuminated duration. An illuminated duration can be present in one or more PWM segments within a clock frame, and one or more other PWM segments with the same clock frame may remain entirely unilluminated.

In accordance with at least one embodiment, repeating brightness is provided. If a brightness value is not received during a clock frame, the existing display brightness level is maintained into the next clock frame. Temporal offsets between clock frame boundaries and display frame boundaries can be accommodated in a flicker-free manner by maintaining the existing display brightness level.

In accordance with at least one embodiment, the output brightness is kept at its existing brightness level until a new brightness value is received. For example, the output brightness may be kept at its existing brightness level until a next display frame is provided (e.g., until the display is next refreshed) and a new brightness value for the next display frame is received.

In accordance with at least one embodiment, a brightness update is performed without immediately resetting a counter to an initial count value. Instead, the counter continues to count clock cycles until a counting limit of the counter is reached. After the counter has reached its counting limit (e.g., highest possible count or lowest possible count), the counter reverts to its initial count value (e.g., lowest possible count or highest possible count) on the next clock cycle of counting after reaching the counting limit. Thus, the resetting of the counter is based on the counter of the counter, not on the occurrence of a display brightness update.

In accordance with at least one embodiment, a display brightness update may be performed in any PWM segment. The timing of a display brightness update is not limited to a single PWM segment (e.g., only the first PWM segment) of a clock frame.

In accordance with at least one embodiment, a display for which a display brightness update is provided may be a liquid-crystal display (LCD) with a backlight, such as a LED backlight. In accordance with at least one embodiment, a display for which a display brightness update is provided may be a LED display, such as a micro-LED display. In accordance with at least one embodiment, a display for which a display brightness update is provided is used on a television (TV). In accordance with at least one embodiment, a display for which a display brightness update is provided is used on a video monitor. In accordance with at least one embodiment, a display for which a display brightness update is provided is used on a notebook computer. In accordance with at least one embodiment, a display for which a display brightness update is provided is used on an automotive heads-up display (HUD), such as a projection heads-up display (PHUD) or other HUD. In accordance with at least one embodiment, a display for which a display brightness update is provided is used on an automotive electronics cluster, such as an information-and-entertainment (infotainment) system.

In accordance with at least one embodiment, ES-PWM is implemented for VRR displays.

In accordance with at least one embodiment, a display brightness update can be made to be effective in any PWM segment within a clock frame. For example, display brightness update can be made effective within a PWM segment in temporal proximity to a time at which a brightness value is received. As examples, a display brightness update may be made effective for an first subsequent (N+1) PWM segment, at second subsequent (N+2) PWM segment, at a third subsequent (N+3) PWM segment, at a fourth subsequent (N+4) PWM segment, at a fifth subsequent (N+5) PWM segment, at a sixth subsequent (N+6) PWM segment, at a seventh subsequent (N+7) PWM segment, at an eighth subsequent (N+8) PWM segment, at a ninth subsequent (N+9) PWM segment, at a tenth subsequent (N+10) PWM segment following an Nth PWM segment at which the brightness value is received or at any other PWM segment in the clock frame. As an example, a PWM segment within 16 PWM segments of a PWM segment at which a brightness value is received can be considered temporally proximate to the PWM segment at which the brightness value is received. Any subsequent PWM segment within the same clock frame during which a brightness value is received is temporally proximate as compared to a relatively temporally distal initial PWM segment of a subsequent clock frame (in the cases of any brightness values received during any PWM segment except the final PWM segment of a clock frame). By making a display brightness update effective shortly after receipt of a brightness value corresponding to the display brightness update, a low latency of display brightness update can be realized. In accordance with at least one embodiment, a clock frame is not truncated upon the performance of a display brightness update. The counter need not be reset immediately after a display brightness update. Rather, the counter may be allowed to continue to count to its counting limit regardless of when in the clock frame (e.g., at which PWM segment within the clock frame) the display brightness update is performed. Regular counting of the counter can maintain regularity of PWM or ES-PWM illumination scheduling, which can avoid flickering.

In accordance with at least one embodiment, flicker-free image performance can be provided. In accordance with at least one embodiment, high-contrast-ratio image performance can be provided.

In accordance with at least one embodiment, a technique as disclosed herein may be implemented across a wide range of PWM and ES-PWM implementations, across a wide range of display refresh rates, including for VRR displays, and across a wide range of display types, including LED, LCD with LED backlight, and other display of variable brightness. In accordance with at least one embodiment, a quick display brightness update can be performed without losing data. In accordance with at least one embodiment, high image resolution can be maintained. In accordance with at least one embodiment, high temporal resolution of display brightness updates can be provided. In accordance with at least one embodiment, VRR support can be provided at low cost for display brightness control.

In accordance with at least one embodiment, a non-PLL-based digital display brightness update is provided without truncation of a count by a counter of clock cycles and without limitation of a PWM segment at which brightness can be changed. A plurality of PWM segments are defined with respect to counts of the counter. The clock can operate at a fixed frequency. The frequency of the clock need not be synchronous with a display refresh rate. The frequency of the clock need not be multiple or submultiple of the display refresh rate. The frequency of the clock can be asynchronous with the display refresh rate. Thus, the clock need not be able to provide a frequency adaptive to the display refresh rate.

In accordance with at least one embodiment, frequency boosting is provided via ES-PWM. ES-PWM can effectively increase the frequency at which PWM is performed by distributing shorter periods of illumination (and corresponding periods of non-illumination) throughout a plurality of PWM segments rather than providing illumination for the entire duration of one or more PWM segments and non-illumination for the entire duration of one or more other PWM segments. In accordance with at least one embodiment, illumination and non-illumination can be implemented in periods of entire PWM segments or groups of PWM segments. A PWM cycle can span, for example, a clock frame.

A previous display brightness level is continuously maintained before and until a next brightness update is applied. For example, when a frame refresh period corresponding to a frame refresh rate is longer than a clock frame, maintaining a previous display brightness level past the end of the clock frame can avoid a lack of illumination, which may be perceived as flickering, past the end of the clock frame. Such a period of lack of illumination could extend, for example, from the end of the clock frame to the beginning of a subsequent display frame, for which a brightness value may be provided upon which a display brightness update may be performed. By preventing non-illumination disruptive to a current PWM or ES-PWM pattern prior to receipt of a brightness value, adverse transient effects on display quality can be avoided.

In accordance with at least one embodiment, the clock may be referred to as a grayscale clock. As an example, for a monochromatic display, the clock may be used to control PWM or ES-PWM to provide a grayscale update between black for a 0% duty cycle and full brightness (e.g., white or a different monochromatic color) for a 100% duty cycle. For example, duty cycles greater than 0% but less than 100% can be specified to provide a desired level of gray or a desired tint.

In accordance with at least one embodiment, a brightness value may be received asynchronously with respect to a clock frame. In accordance with at least one embodiment, a display brightness update may be performed asynchronously with respect to a clock frame. As an example, an arbitrary-PWM-segment intra-clock-frame display brightness may be performed. In accordance with at least one embodiment, display-frame-to-display-frame-continuous display backlighting can be provided.

While various embodiments may be implemented according to a variety of parameter values, some examples are set forth below. As an example, a clock rate may be in a range of 5 megahertz (MHz) to 50 MHz. For example, the clock rate may be 30 MHz to 35 MHz, such as 33 MHz. As an example, a clock frame may comprise 65,536 cycles (e.g., according to a maximum count for a 16-bit binary counter). As an example, the clock cycles may be counted from zero to a maximum value of one less than the number of clock cycles (e.g., from zero to 65,535). As an example, the clock cycles may be counted from a maximum value to zero. As an example, a clock frame may be divided temporally into a plurality of PWM segments. As an example, the number of PWM segments may be a power of two, that is, the number two raised to the power of an integer exponent. As an example, the number of PWM segments may be 27=128. When 128 PWM segments are counted using a 16-bit counter, each PWM segment may have a duration of 216/27=29 (65,536/128=512) clock cycles.

In accordance with at least one embodiment, the count of the counter continues untruncated following a display brightness update. The counter is allowed to continue counting from its initial count to its final count of a clock frame in which a display brightness update is performed without resetting the counter until the end of the clock frame. Accordingly, the clock frame is no truncated but has the same length as other clock frames, for example, a clock frame in which no display brightness update is performed. As an example, the number of clock cycles in a clock frame can be invariant regardless of the occurrence and timing or non-occurrence of a display brightness update.

In accordance with at least one embodiment, a display brightness update can be performed at any PWM segment within a clock frame (e.g., at a PWM segment occurring shortly after receipt of a display brightness update, for example, at the next PWM segment immediately following a PWM segment in which the brightness value for the display brightness update was received). Display brightness updates need not occur at an ordinally regular points in clock frames, such as at the first clock cycle of a next clock frame following receipt of a brightness value.

According to at least one embodiment, a digital display brightness control technique is used, such as PWM or ES-PWM, rather than an analog display brightness control technique. A digital display brightness control technique can offer higher brightness resolution and can be more immune to interference, for example, electromagnetic interference (EMI) or radio-frequency interference (RFI) from stray fields in the vicinity of a display.

In accordance with at least one embodiment, a display brightness update is performed more frequently than a clock frame. The clock frame has a regular length. The clock frame length is independent of a timing of a display brightness update performed within the clock frame. The timing of display brightness updates can vary among various clock frames. The durations from the display brightness updates to the ends of their respective clock frames can vary among clock frames. The length of the clock frame remains invariant. The counter can run continuously, counting contiguous counter values, for the length of the clock frame.

In accordance with at least one embodiment, the outputting of a display brightness signal (e.g., a PWM display dimming signal or other signal to specify a desired perceived display brightness of a display) is based on a first brightness value applied during a first PWM segment counter value. A PWM segment counter counts to its limit value after applying the first brightness value. The PWM segment counter counted from a PWM segment counter starting value to a first previous PWM segment counter value within one count of the first PWM segment counter value. The outputting the PWM display brightness signal is based on a second brightness value applied during a second PWM segment counter value. The PWM segment counter counts to a PWM segment counter limit value after applying the second brightness value. The PWM segment counter counted from a PWM segment counter starting value to a second previous PWM segment counter value within one count of the second PWM segment counter value. The first PWM segment counter value is not equal to the second PWM segment counter value. The first PWM segment counter value is not equal to the PWM segment counter starting value.

In accordance with Example 1, a circuit comprises an input configured to receive a brightness value; a clock configured to provide a clock signal of clock pulses at a clock rate; a counter, the counter connected to the clock, the counter configured to count a count of clock pulses; and a controller, the controller connected to the input and to the counter, the controller configured to control a display brightness according to the brightness value and the count, wherein the controller is configured to perform, upon receiving the brightness value at the input, a digital display brightness update at a temporally proximate PWM segment in a clock frame, wherein a positive integer number of PWM segments occur within the clock frame, wherein the clock frame corresponds to a counted duration corresponding to a counting range of the counter, with contiguous counting over an entirety of the clock frame, wherein the controller causes uninterrupted illumination to be maintained from a first display frame to a second display frame, the second display frame being immediately subsequent to the first display frame.

In accordance with Example 2, a transition of the count of the counter from final count value to an initial count value is not temporally aligned with a display frame boundary.

In accordance with Example, 3, a transition of the count of the counter to an initial count value is asynchronous with a display frame boundary.

In accordance with Example 4, counting cycle of unique count values is asynchronous with a display frame duration, wherein a next counting cycle begins after counter overflow.

In accordance with Example 5, the counting cycle of unique count values is asynchronous with a display frame duration, wherein the count changes regularly from a first extreme count value to a second extreme count value even after the digital display brightness update is initiated.

In accordance with Example 6, the clock rate operates in an open-loop manner.

In accordance with Example 7, the clock rate is fixed.

In accordance with Example 8, a circuit comprises a clock; a counter connected to the clock; a light-emitting diode (LED) driver circuit; and a controller, the controller connected to the counter and to the LED driver circuit, the controller configured to receive a brightness value, the clock configured to operate at a clock rate asynchronous with a display frame rate, the counter configured to count clock cycles of the clock in pulse-width modulation (PWM) segments, wherein a positive integer number of PWM segments occur within a clock frame, the controller further configured to cause the LED driver circuit to modify a LED brightness at a PWM segment occurring before an end of the clock frame. As an example, the counting continues to the end of the clock frame.

In accordance with Example 9, the counter continues to count to the end of the clock frame.

In accordance with Example 10, the end of the clock frame occurs at an invariant final counter value.

In accordance with Example 11, the end of the clock frame occurs at a limit of a counter capacity of the counter.

In accordance with Example 12, the clock rate is fixed.

In accordance with Example 13, the clock operates without influence of a phase-locked loop (PLL).

In accordance with Example 14, an existing LED brightness level is continuously maintained before and until a next brightness value is applied to modify the LED brightness to a next LED brightness level corresponding to the next brightness value.

In accordance with Example 15, a circuit comprises a clock; a counter, the counter connected to the clock; a light-emitting diode (LED) driver circuit; and a controller, the controller connected to the counter and to the LED driver circuit, wherein the counter is configured to count brightness clock cycles until a next pulse-width modulation (PWM) segment boundary and to cause, when a brightness value has been received, the LED driver circuit to modify a LED brightness at a PWM segment before an end of the clock frame, and wherein the counter is configured to reset when a count of the counter has reached the end of the clock frame. As an example, the end of the clock frame occurs at a regular interval unchanged by the occurrence of the brightness value having been received.

In accordance with Example 16, the counter is inhibited from being reset before the count of the counter has reached the end of the clock frame.

In accordance with Example 17, the end of the clock frame occurs at an invariant final counter value.

In accordance with Example 18, the end of the clock frame occurs at a limit of a counter capacity of the counter.

In accordance with Example 19, the clock rate is fixed.

In accordance with Example 20, the clock operates without influence of a phase-locked loop (PLL).

In this description, the term “couple” may cover connections, communications or signal paths that enable a functional relationship consistent with this description. Accordingly, if device A generates a signal to control device B to perform an action, then: (a) in a first example, device A is coupled directly to device B; or (b) in a second example, device A is coupled to device B through intervening component C if intervening component C does not substantially alter the functional relationship between device A and device B, so device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device, or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a field effect transistor, a bipolar junction transistor (BJT—e.g., NPN or PNP), insulated gate bipolar transistors (IGBTs), and/or junction field effect transistor (JFET) may be used in place of or in conjunction with the devices described herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples are included in an integrated circuit and other elements are external to the integrated circuit, in other examples, additional or fewer features may be incorporated into the integrated circuit. Also, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of that parameter. Modifications are possible in the described examples, and other implementations are possible, within the scope of the claims.

What is claimed is:

1. A circuit comprising:
an input configured to receive a brightness value;
a clock configured to provide a clock signal of clock pulses at a clock rate;
a counter, the counter connected to the clock, the counter configured to count a count of clock pulses; and
a controller, the controller connected to the input and to the counter, the controller configured to control a display brightness according to the brightness value and the count, wherein the controller is configured to perform, upon receiving the brightness value at the input, a digital display brightness update at a temporally proximate PWM segment in a clock frame, wherein a positive integer number of PWM segments occur within the clock frame, wherein the clock frame corresponds to a counted duration corresponding to a counting range of the counter, with contiguous counting over an entirety of the clock frame, wherein the controller causes uninterrupted illumination to be maintained from a first display frame to a second display frame, the second display frame being immediately subsequent to the first display frame.

2. The circuit of claim 1, wherein a transition of the count of the counter from final count value to an initial count value is not temporally aligned with a display frame boundary.

3. The circuit of claim 2, wherein a transition of the count of the counter to an initial count value is asynchronous with a display frame boundary.

4. The circuit of claim 1, wherein a counting cycle of unique count values is asynchronous with a display frame duration, wherein a next counting cycle begins after counter overflow.

5. The circuit of claim 1, wherein a counting cycle of unique count values is asynchronous with a display frame duration, wherein the count changes regularly from a first extreme count value to a second extreme count value even after the digital display brightness update is initiated.

6. The circuit of claim 1, wherein the clock rate operates in an open-loop manner.

7. The circuit of claim 6, wherein the clock rate is fixed.

8. A circuit comprising:
a clock;
a counter connected to the clock;
a light-emitting diode (LED) driver circuit; and
a controller, the controller connected to the counter and to the LED driver circuit, the controller configured to receive a brightness value, the clock configured to operate at a clock rate asynchronous with a display frame rate, the counter configured to count clock cycles of the clock in pulse-width modulation (PWM) segments, wherein a positive integer number of PWM segments occur within a clock frame, the controller further configured to cause the LED driver circuit to modify a LED brightness at a PWM segment occurring before an end of the clock frame.

9. The circuit of claim 8, wherein the counter continues to count to the end of the clock frame.

10. The circuit of claim 9, wherein the end of the clock frame occurs at an invariant final counter value.

11. The circuit of claim 10, wherein the end of the clock frame occurs at a limit of a counter capacity of the counter.

12. The circuit of claim 8, wherein the clock rate is fixed.

13. The circuit of claim 12, wherein the clock operates without influence of a phase-locked loop (PLL).

14. The circuit of claim 13, an existing LED brightness level is continuously maintained before and until a next brightness value is applied to modify the LED brightness to a next LED brightness level corresponding to the next brightness value.

15. A circuit comprising:
a clock;
a counter, the counter connected to the clock;
a light-emitting diode (LED) driver circuit; and
a controller, the controller connected to the counter and to the LED driver circuit, wherein the counter is configured to count brightness clock cycles until a next pulse-width modulation (PWM) segment boundary and to cause, when a brightness value has been received, the LED driver circuit to modify a LED brightness at a PWM segment before an end of a clock frame, and wherein the counter is configured to reset when a count of the counter has reached the end of the clock frame.

16. The circuit of claim 15, wherein the counter is inhibited from being reset before the count of the counter has reached the end of the clock frame.

17. The circuit of claim 15, wherein the end of the clock frame occurs at an invariant final counter value.

18. The circuit of claim 15, wherein the end of the clock frame occurs at a limit of a counter capacity of the counter.

19. The circuit of claim 18, wherein a clock rate of the clock is fixed.

20. The circuit of claim 19, wherein the clock operates without influence of a phase-locked loop (PLL).
